(19) United States
(12) Patent Application Publication
(10) Pub. No.: US 2016/0328784 A1
(43) Pub. Date: Nov. 10, 2016

(54) SYSTEM AND METHOD FOR MAPPING PRODUCT LOCATIONS

(71) Applicant: Wal-Mart Stores, Inc., Bentonville, AR (US)

(72) Inventors: Matthew Allen Jones, Bentonville, AR (US); Robert James Taylor, Rogers, AR (US); Nicholaus Adam Jones, Fayetteville, AR (US); Marc Ashley Fletter, Bentonville, AR (US); Daniel R. Shields, Rogers, AR (US)

(21) Appl. No.: 15/095,451

(22) Filed: Apr. 11, 2016

Related U.S. Application Data
(60) Provisional application No. 62/156,603, filed on May 4, 2015.

(51) Int. Cl. G06Q 30/06; G01C 22/00; H04W 4/04

(52) U.S. Cl. CPC G06Q 30/0639; H04W 4/04; G01C 22/006

(57) ABSTRACT

Disclosed is a system and method for mapping a retail store. The system collects time stamps and data captures such as barcode scans from a plurality of mobile computing devices, as the mobile computing devices are carried by employees or customers between a plurality of locations in a retail store. The time stamps and data captures are used to compute distances between the product locations associated with each of the data captures. The distances and locations are mapped on a map of the retail store. The system may also collect pedometer data from the mobile computing devices and use the pedometer data to update and refine the distance calculations. In other instances, the system collects directional data from the mobile computing devices. The directional data is used to map directional paths between the locations. The map of the retail store can be used to direct customers and employees.

### CROSS REFERENCE TO RELATED APPLICATION

This application claims priority to U.S. Provisional Patent Application Ser. No. 62/156,603 to Wal-Mart Stores Inc., filed May 4, 2015 and entitled “System and Method For Mapping Product Locations”, which is hereby incorporated entirely herein by reference.

### FIELD OF THE INVENTION

The invention relates generally to mapping buildings, and specifically to a system for mapping a retail store.

### BACKGROUND

Within a retail store, time and effort is expended to determine the relative location of products, store fixtures, and other items, and how to most efficiently travel from one location to another to accomplish high priority work. Stores often have locations that are assigned and numbered, but the distance between many items in stores is often not well known. Having employees spend time to measure and map distances takes time, and keeps the employees from doing other work. It is desirable to have a system and method of automatically collecting location, time, and direction of travel data as employees, customers and other individuals travel throughout different locations in a retail store while either shopping or doing their jobs, and a system and method of using this data to map locations in a retail store.

### BRIEF SUMMARY

Disclosed is a method of mapping product locations that includes collecting a plurality of time stamps from a plurality of mobile computing devices located at any one of a plurality of product locations in a retail store, where each one of the plurality of mobile computing devices is carried by a corresponding one of a plurality of individuals as the plurality of individuals travel between the plurality of product locations. The method also includes using the plurality of time stamps to calculate a plurality of distances, where each one of the plurality of distances represents a distance between two of the plurality of product locations, and forming a product location map comprising the plurality of product locations and the plurality of distances.

Disclosed is a system for mapping a retail store that includes a communication module, a distance module, a location module, and a mapping module. The communication module receives a first and a second time stamp, and a first and a second product data capture from a mobile computing device. The mobile computing device can be carried by any individual in or around a building to be mapped, such as a retail store. The location module associates the first time stamp to a first location in the retail store, and the location module associates the second time stamp to a second location in the retail store. The distance module uses the first and the second time stamps to compute a distance between the first and the second location. The mapping module maps the first and the second location and the distance on a map.

In another aspect, disclosed is a store mapping system that includes a means for collecting a first time stamp associated with a first location in the store, and a second time stamp associated with a second location in the store. The store mapping system also includes a distance module that uses the first and the second time stamps to compute a distance between the first and the second location, and a mapping module that maps the distance and the first and the second locations.

In another aspect, provided is a method of mapping product locations. The method includes collecting a first time stamp and a first product scan from a mobile computing device at a first product location, and collecting a second time stamp and a second product scan from the mobile computing device at a second product location. The method of mapping product locations also includes using the first and the second time stamps to calculate a distance between the first product location and the second product location. The method includes creating a product location map comprising the first product location, the second product location, and the distance.

### BRIEF DESCRIPTION OF THE SEVERAL VIEWS OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is an illustrative view of a store mapping system.

FIG. 2 illustrates a block diagram of a computer system for mapping a retail store.

FIG. 3 illustrates the store mapping system of FIG. 1 receiving communication from a mobile computing device as the mobile computing device is carried from a first location to a second location.

FIG. 4 shows a map 120 of a retail store with a first and a second location and a distance between the first and the second location.

FIG. 5 shows map 120 of FIG. 3 with an additional location and distance mapped.

FIG. 6 shows map 120 of FIG. 3 with a third distance mapped.

FIG. 7 shows map 120 of FIG. 3 with a fourth distance mapped.

FIG. 8 shows map 120 of FIG. 3 with a plurality of distances mapped.

FIG. 9 shows a map 220 with a directional path between a first distance and a second distance mapped.

FIG. 10 shows map 220 of FIG. 8 with a second and a third directional path mapped.

FIG. 11 shows map 220 with a plurality of directional paths mapped.

FIG. 12 illustrates a method of mapping a store.

FIG. 13 illustrates a method of mapping product locations.

### DETAILED DESCRIPTION OF EMBODIMENTS OF THE INVENTION

Disclosed herein is a system and method for mapping a building such as a retail store. The system collects data captures such as barcode scans, and associated time stamps, from mobile computing devices at various locations in a retail store, as individuals carrying the mobile computing devices travel about the store. The disclosed system uses the time stamps to compute distances between locations associated with the data captures, such as product location or physical locations. The distances between the locations are used to map the retail store. The disclosed system may also collect accelerometer, pedometer, or compass data from the mobile computing devices, to the extent this data is available, and adds this data to the map of the building or retail store. Because many employees and customers travel throughout a retail store on a daily basis, a large amount of data can be obtained and used to refine distances, locations, and directional paths on the retail store map. Geometric calculations are used to fill in missing data where necessary.

Locations within retail stores and the distances between the locations are often not well identified or mapped. It is desirable to know the relative location and distance between locations and items in a store for any number of reason, including so that employees can be directed to perform tasks using the most efficient path, customers can be directed to products and locations, or an employee closest to a location can be directed to attend to urgent matters, for example. It is also desirable to know the locations of products in the retail store and the relative distances between product locations.

Mobile computing devices such as tablets, cell phones, and portable scanners are often used by both customers and employees as they move about a store. Customers are often provided with mobile computing devices to use while they are in a store for the purpose of scanning products for information or remote check-out, for example. Retail stores also provide applications to reside on the personal mobile computing devices of customers, for use in remote check out, obtaining coupons, or tracking products. Store employees are equipped with portable scanners and other mobile computing devices, and are constantly moving about the store scanning product or location barcodes as they do their jobs. These mobile computing devices are capable of, or already are, providing wireless data pertaining to when the mobile computing device is located at a particular location or barcode. Thus, employees and customers already interact wirelessly with one or more store servers using their portable scanners or tablets. Organizing the means to collect scanned barcode and time stamp data from customers and employees as they move about the store, and adding methods of processing this data to obtain distances between barcode scans in a store, results in obtaining location and distance information that can be used to map a store, and/or to augment existing store maps, either digital or paper. In addition, many of the mobile computing devices carried by individuals such as employees or customers are equipped to provide pedometer data or compass data as the individual travels about the store. Collecting this data as individuals move between product or location barcode scans in the store increases the depth and accuracy of mapping data that can be used for mapping purposes. The disclosed system and method of mapping a retail store captures time stamps, data captures such as product and location barcode scan data, pedometer data, accelerometer data, and other related data from the mobile computing devices of individuals as they travel around a building. This data is used to map distances and locations on a product location map or a retail store map, either building a map from scratch, adding to existing store maps, or both.

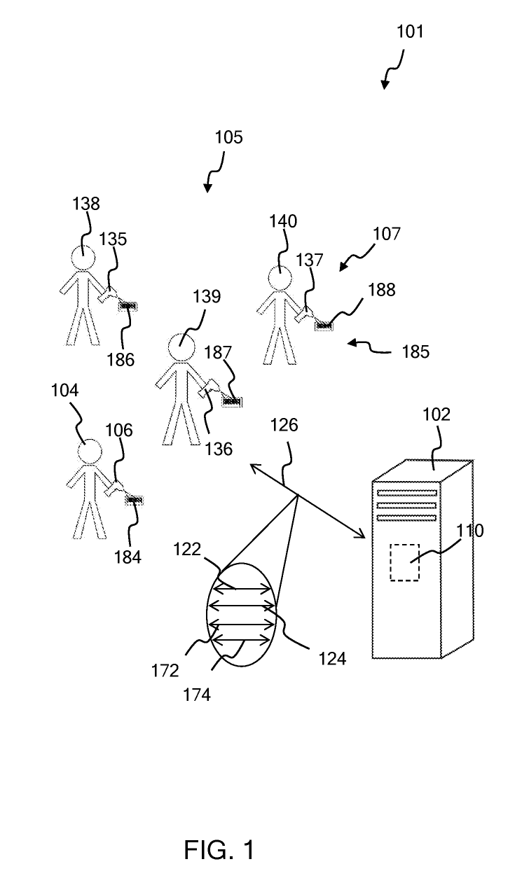

FIG. 1 illustrates a system 101 for mapping a retail store or a building. System 101 in this embodiment includes a server 102 with a computer system 110 for mapping a retail store. In this embodiment, system 110 is a computer program, but it is to be understood that computer system 110 can take many forms and implementations, including hardware, software, or both. System 110 is resident on server 102 in this embodiment, but it is to be understood that system 110 can be a part of any computational equipment. In a particular embodiment, system 110 is implemented in hardware processors. The hardware processors can be application specific integrated circuits (ASICs) or hardware accelerators, for example. The hardware processors can be part of one or more special purpose computers that execute computer program instructions which implement one or more functions and operations of computer system 110.

Server 102 in the embodiment shown in FIG. 1 is a retail store server, but this is not meant to be limiting. Server 102 may be available via the internet, cloud computing services, or other remote server services.

Server 102 receives communication 126 from a plurality of mobile computing devices 107, which are carried by a plurality of individuals 105 as plurality of individuals 105 travel about the retail store. In this embodiment plurality of individuals includes individuals 104, 138, 139, and 140. In this embodiment plurality of mobile computing devices includes mobile computing devices 106, 135, 136, and 137. Plurality of mobile computing devices 107 are used by plurality of individuals 105 to scan a plurality of barcodes 185. In this embodiment plurality of barcodes includes barcode 184, 186, 187, and 188. Each one of plurality of barcodes 185 can be a product barcode, a QR codes, a location barcode, or any other barcode or scannable identifier located in a building or store.

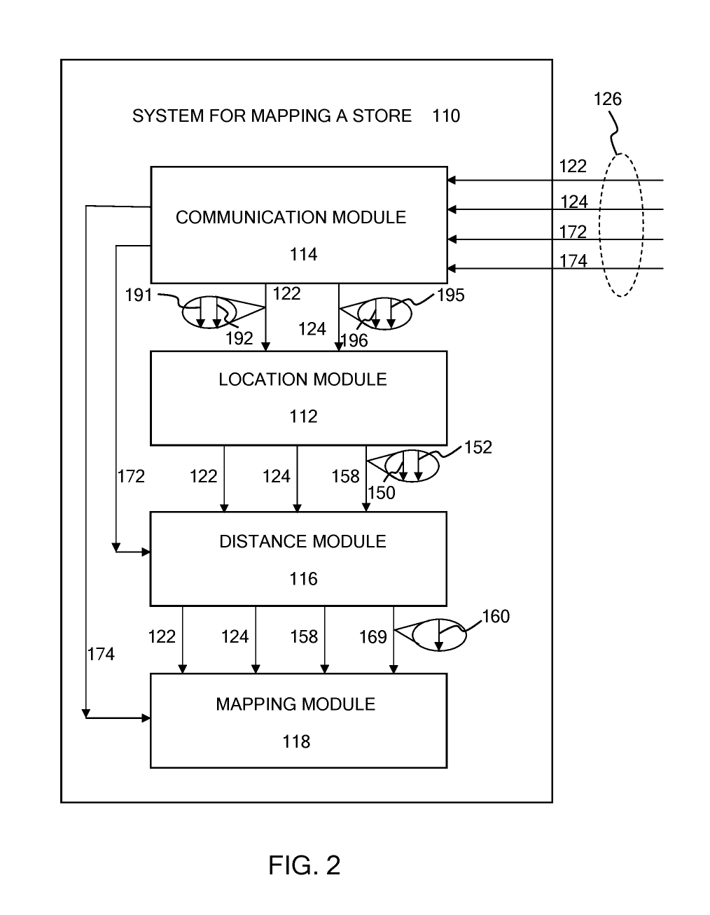

Each one of plurality of mobile computing devices 107 transmits a portion of communication 126 to system 110 of server 102 as plurality of mobile computing devices 107 are used by plurality of individuals 105 to scan plurality of barcodes 184 in the store. Communication 126 includes one or more of: a plurality of time stamps 122, a plurality of data captures 124, a plurality of pedometer data 172, and a plurality of directional data 174, as shown in FIG. 1 and FIG. 2. In some embodiments, communication 126 includes additional types of data. Data capture 124 can be a scan of a product or location barcode, but this is not meant to be limiting. Data capture 124 can be any type of data capture received from one of plurality of mobile computing device 107. Data capture 124 can be a scan of a barcode, a QR code, a MICROSOFT™ Tag, or any other type of scanned data entry. Data capture 124 can be a manual entry of barcode data, QR code data, MICROSOFT™ Tag data, or other manual data entry. Data capture can be any receipt of data using a single sensor or a linear array of sensors. A data capture 124 can be the receipt of laser light reflected off a label, barcode, QR code, or other printed label or surface. Data capture 124 can be the capture of a picture using a two-dimensional array of sensors such as a cellphone camera sensor. Data capture 124 can be the receipt of data using near field communications (NFC) devices or other type of electronic or optical data transfer means. Data capture 124 can be the receipt of any form of information usable by system 110.

Each time one of plurality of barcodes 185 is scanned with one of plurality of mobile computing devices 107, the particular mobile computing device that did the scanning transmits a time stamp and a barcode scan to system 110 of server 102. The time stamp represents the time that the barcode was scanned. When any of plurality of mobile computing devices 107 is equipped with a pedometer, the pedometer transmits pedometer data 172 to system 110 of server 102 as the particular mobile computing device is carried between locations in the store. Pedometer data 172 is used to determine the number of steps taken between locations in the store. Many cellular telephones, mobile pedometer devices, and other mobile computing devices have the ability to collect and transmit pedometer data 172. Pedometer data 172 can be obtained from an accelerometer or other type of sensor in any one of plurality of mobile computing devices 107.

When any of plurality of mobile computing devices 107 is equipped with a directional device such as a compass, a GPS, or an accelerometer, the directional device transmits directional data 174 to system 110 of server 102 as the particular mobile computing device is carried between locations in the store. A directional device is any device capable of providing directional data 174, where directional data 174 indicates the direction of movement of the associated mobile computing device. Directional data 174 can be supplied by an accelerometer sensor in a mobile computing device, a compass in a mobile computing device, a global positioning sensor (GPS) in a mobile computing device, or any other type of sensor or electronic apparatus capable of providing directional data 174.

Communication 126 in the embodiment shown in FIG. 1 is wireless communication between each of plurality of mobile computing devices 107 and computer system 110 of server 102, but this is not meant to be limiting. Wireless communication 126 can be a Bluetooth communication, a wireless local area network, wireless cellular telephone communication, or any other form or type of wireless communication. In some embodiments, communication 126 is wired or optical communication.

Plurality of mobile computing devices 107 can be one of many different types of devices suited for plurality of individuals 107 to communicate with server 102 and computer system 110. In this embodiment, each one of plurality of mobile computing devices 107 is a portable scanner 106. Mobile computing device 106 can be a mobile phone, a tablet, a handheld computer, or any other mobile computing device with the ability to scan a barcode 184 and communicate with server 102.

Plurality of mobile computing devices 107 are carried by plurality of individuals 105 while shopping or working in or around the retail store. Plurality of mobile computing devices 107 are used by plurality of individuals 105 to scan plurality of barcodes 185 as shown in FIG. 1. Any one of plurality of individuals 105 may scan one of plurality of barcodes 185 for many different reasons. For example if individual 104 is a shopper, individual 104 could scan product barcode 184 as they put the product with barcode 184 in their cart. In this example, mobile computing device 106 can keep track of the products and the total cost of the products in the shopping cart of individual 104. In some embodiments, mobile computing device 106 can execute remote checkout of individual 104. In another example, individual 104 that is a customer may scan a product barcode 184 to get information or a price of the product with barcode 184. Or, individual 104 may scan a location barcode 184 in order to get information on where they are in the retail store. Individual 104 that is a customer has many different reasons for scanning a barcode 184 with mobile computing device 106.

In some embodiments, individual 104 is an employee. Individual 104 that is an employee will be scanning barcode 184 while they do their jobs. Individual 104 may be scanning a product barcode 184 while they are conducting inventory checks. Individual 104 may be scanning a location barcode 184 when they perform a task at the location. An individual 104 that is an employee may be scanning barcodes 184 for many different reasons.

Plurality of individuals 105 travel from location to location within the retail store or other building, scanning plurality of barcodes 185 with plurality of mobile computing devices 107, and transmitting plurality of data captures 124, plurality of time stamps 122, pedometer data 172 and directional data 174 as plurality of individuals 107 travel among locations in the retail store. System for mapping a retail store 110 resident on server 102 receives communication 126, comprising time stamps 122, data captures 124, pedometer data 172 (when available) and directional data 174 (when available) from plurality of mobile computing devices 107. System 110 uses communication 126 to create a map of the retail store as explained herein.

FIG. 2 shows a block diagram of one embodiment of system for mapping a retail store 110. System 110 includes a communication module 114, a location module 112, a distance module 116, and a mapping module 118. A “module”, as used in this document, can be a circuit, a software program, a hardware apparatus, an application specific integrated circuit, a special purpose computer, or a combination of hardware and software circuits, systems, or implementations. A module can be any element, thing, or program that accepts one or more input and provides one or more output. System 110 in this embodiment is a computer implemented system, but this is not meant to be limiting. System 110 can be implemented in hardware, firmware, software, or any combination of these. In a particular embodiment, communication module 114, location module 112, distance module 116, and mapping module 118 are each implemented as an application specific integrated circuit. In another specific embodiment, communication module 114, location module 112, distance module 116, and mapping module 118 are each implemented as a hardware processor. In some embodiments, each hardware processor is a hardware accelerator that interfaces with a computer program. In some embodiments, each hardware processor is a part of one or more special purpose computer that executes computer program instructions.

Communication module 114 accepts as input communication 126 from plurality of mobile computing device 107. Communication 126 includes plurality of time stamps 122, plurality of data captures 124, pedometer data 172, and directional data 174 from plurality of mobile computing devices 107. Communication module 114 directs plurality of time stamps 122 and plurality of data captures 124 to location module 112. Communication module 114 directs pedometer data 172 to distance module 116, and communication module 114 sends directional data 174 to mapping module 118.

Location module 112 associates each one of plurality of time stamps 122 and plurality of data captures 124 to a location in the retail store. The location may be a product location, a physical location, or the location where a specific one of plurality of time stamps 122 and plurality of data captures 124 was collected. For example, if one of plurality of data captures 124 is a product barcode scan, location module 112 will associate the time stamp and the barcode scan to the location of the product identified by the product barcode scan. When data capture 124 is a product barcode scan, location module 112 assigns a product associated with the product barcode scan to a location. Thus the locations are often product locations. Location module 112 receives plurality of time stamps 122 and plurality of data captures 124, and outputs a plurality of locations 158, where each one of plurality of locations 158 is associated with a specific pair of plurality of times stamps 122 and plurality of data captures 124.

Distance module 116 uses pairs of plurality of time stamps 122 to compute a plurality of distances 169, where each specific one of plurality of distances 169 is the distance between two of plurality of locations 158 associated with a pair of plurality of time stamps 122 and plurality of data captures 124. The distance can be computed in many ways, such as by estimating a walking speed, differencing the time stamps, and multiplying the differenced time stamps by the walking speed to compute a distance between the two locations where the two time stamps were collected. If distance module 116 also receives pedometer data 172 that corresponds to the plurality of time stamps 122 and plurality of locations 158, distance module 116 will compute a second distance calculation using pedometer data 172, and compare it to the first distance calculation using the time stamps. Distance module 116 will use any amount of distance data that is received or computed to generate a distance between two of plurality of locations associated with two of plurality of time stamps 122 and plurality of data captures 124.

Mapping module 118 maps plurality of locations 158 and plurality of distances 169 on a map of the retail store. If mapping module 118 receives directional data 174, mapping module 118 also maps directional paths between plurality of locations 158 on the map of the retail store. The map can be a product location map, a physical location map, a combination of these, or a map of any other type of locations in or around a building or retail store. In some embodiments, mapping module 118 maps products to one or more of the plurality of locations 158.

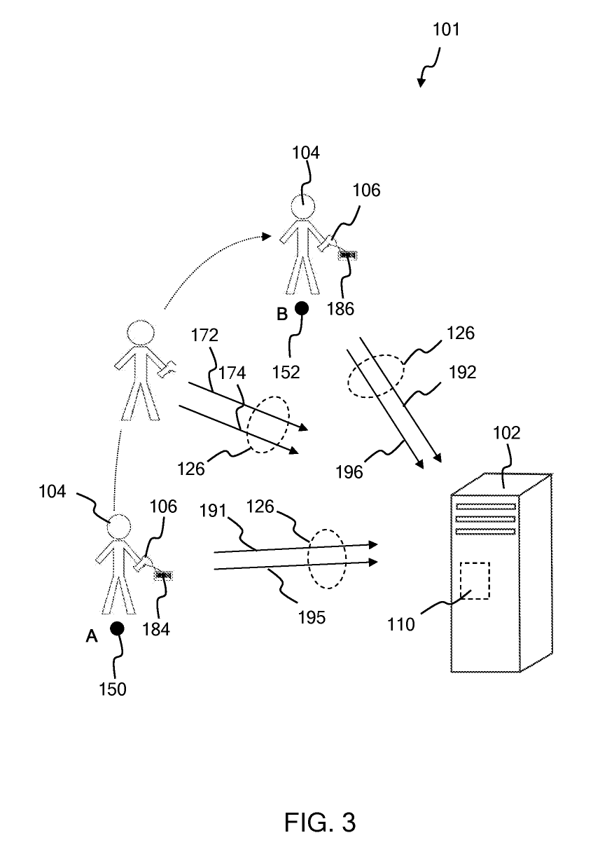

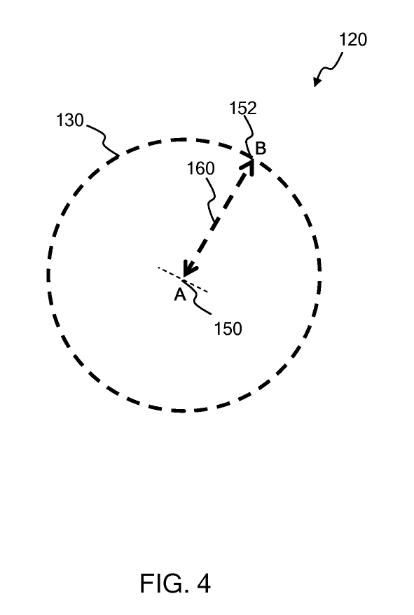

FIG. 2, FIG. 3, and FIG. 4 illustrate an example of system 110 for mapping a retail store collecting communication 126, and using communication 126 to build a retail store map. FIG. 3 illustrates system 110 collecting communication 126 from a mobile computing device 106 at two different product locations, a first product location A 150, and a second product location B 152. First product location 150 is the location of a first product with a barcode 184. Second product location 152 is the location of a second product with a barcode 186. In this example embodiment, locations 150 and 152 are product locations associated with product barcodes 184 and 186, but it is to be understood that locations 150 and 152 can be any locations associated with a barcode and a time stamp of when the barcode was scanned.

FIG. 4 illustrates a product location map 120 created by system 110 for mapping a retail store using communication 126 as shown in FIG. 3.

Referring to FIG. 3, individual 104 scans product barcode 184 using mobile computing device 106, while individual 104 is at first product location A. Product location A is referred to as product location 150 in the figures. System 110 for mapping a retail store of server 102 receives communication 126 from mobile computing device 106 while individual 104 and mobile computing device 106 are at product location 150. Communication 126 while individual 104 and mobile computing device 106 are at product location 150 includes a first time stamp 191 and a first product barcode scan 195. System 110 collects first time stamp 191 and first product barcode scan 195 from mobile computing device 106 while mobile computing device 106 is at first product location 150. Individual 104 then travels to a second product location B, labeled 152 in the figures, and scans product barcode 186 using mobile communication device 106. System 110 collects a second time stamp 192 and a second product barcode scan 196 from mobile computing device 106 while mobile computing device 106 is at second product location 152. First and second time stamps 191 and 192 are a part of plurality of time stamps 122 as shown in FIG. 2. First and second barcode scans 195 and 196 are a part of plurality of data captures 124 as shown in FIG. 2.

Referring to FIG. 2, communication module 114 of system 110 for mapping a store receives plurality of time stamps 122, which in this example includes first time stamp 191 and second time stamp 192 from mobile computing device 106. Communication module 114 also receives plurality of data captures 124, which in this example includes first product barcode scan 195 and second product barcode scan 196, from mobile computing device 106.

Communication module 114 delivers plurality of time stamps 122, and plurality of product data captures 124, to location module 112. Location module 112 does not know specifically where individual 104 was when first and second time stamps 191 and 192, and first and second product barcode scans 195 and 196 were received. But location module 112 knows first product barcode scan 195 was generated by product barcode 184, which it knows is on a first product type at first product location A 150. Location module 112 associates first time stamp 191 and first product barcode scan 195 with product location 150. If another product barcode scan is received from product barcode 184, location module 112 will either associate that time stamp and barcode scan data with location A 150, or determine from other data received that the first product type has another location in the store. Similarly, location module 112 associates second time stamp 192 and second product barcode scan 196 with second product location B 152.

Location module 112 delivers first and second time stamps 191 and 192 (part of plurality of time stamps 122), first and second product barcode scans 195 and 196 (part of plurality of data captures 124, and associated first and second product location 150 and 152 (part of plurality of locations 158) to distance module 116.

Distance module 116 uses first and second time stamp 191 and 192 to compute a distance between first product location 150 and second product location 152. Distance module 116 can compute this distance in many different ways, for example by using an estimated walking speed and the time difference between first time stamp 191 and second time stamp 192. Distance module 116 computes a first distance 160 (FIG. 4 discussed below) between first product location 150 and second product location 152.

Distance module 116 delivers first and second time stamps 191 and 192 (part of plurality of time stamps 122), first and second product barcode scans 195 and 196 (part of plurality of data captures 124, first and second product locations 150 and 152 (part of plurality of locations 158), and first distance 160 (part of plurality of distances 169) to mapping module 118.

Mapping module 118 maps first and second locations 150 and 152, and first distance 160 on a map 120, as shown in FIG. 4. In this example, first and second locations 150 and 152 are the first locations to be mapped. Mapping module 118, in this example, does not know specifically where first and second locations 150 and 152 are, but it knows there are two product locations 150 and 152, and that they are a distance 160 apart. At this point mapping module 118 does not know the spatial relationship between product locations 150 and 152. Mapping module 118 knows there is a first product location 150, and that second product location 152 is a distance 160 from first product location 150, so second product location 152 can be anywhere on circle 130 centered at first product location 150, with a radius 160.

In some embodiments, mobile computing device 106 transmits pedometer data 172 to communication module 114 as individual 104 moves from first product location 150 to second product location 152, as shown in FIG. 3. In this instance, communication module 114 delivers pedometer data 172 to distance module 116. Distance module 116 uses pedometer data 172 to make a second computation representing distance 160. Distance module 116 can use the second computation of distance 160 to update the first computation of distance 160. “Update” as used in this document means to compare and, in some embodiments altering the first distance. If the two distances are the same, then no changes may be necessary to first distance. If the distances are different, updating can mean replacing the first distance with the second distance, or updating can mean averaging the first and second distance and replacing the first distance with the second distance. Updating means any computation or step that refines the first distance with the intent of getting the first distance as close as possible to the actual physical distance. Each separate computation of distance 160 is an estimate, but as system 110 receives more and more data that distance module 116 can use to compute distance 160, the estimate of distance 160 used on map 120 will be refined. System 110 uses a plurality of additional time stamps 122 and a plurality of pedometer data 172 from plurality of mobile computing devices 107 carried by plurality of individuals 105 as they travel between first product location 150 and second product location 152 to recalculate and determine distance 160 between first product location 150 and second product location 152.

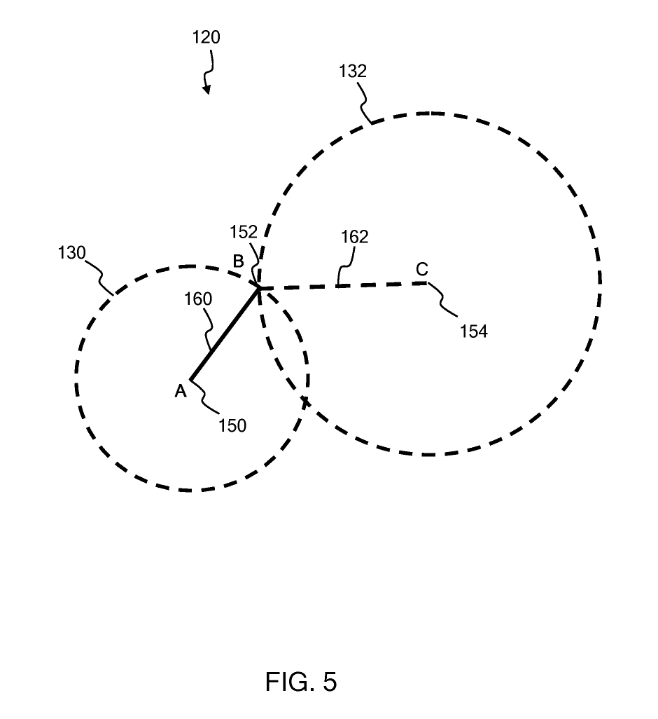

Similarly, and as shown in FIG. 5, system 110 receives a third time stamp and a third product barcode scan from mobile computing device 106 at a third product location C, designated in the figures as location 154. Distance module 116 uses the second and the third time stamps to calculate a second distance 162 between third product location 154 and second product location 152. Mapping module 118 maps second distance 162 and third product location 154 on map 120, as shown in FIG. 5.

Mapping module 118 in this example does not know the spatial relationship between third product location 154 and second product location 152, but it is known that second product location 152 is positioned somewhere on circle 132 centered at third product location 154 with a radius equal to distance 162. Map 120 as shown in FIG. 5 illustrates the known distances 160 and 162, and how product location 152 and 154 can vary in space with respect to product location 150.

It is to be understood that distance 162 can be computed using data from a mobile computing device other than first mobile computing device 106. Any of plurality of time stamps 122 and plurality of product data captures 124 from any one of plurality of mobile computing devices 107, as the particular one of plurality of mobile computing devices 107 is carried from third product location 154 to second product location 152, or vice versa, can be used to compute second distance 162. And similarly, as more data is received from plurality of mobile computing devices 107 carried by plurality of individuals 105 traveling between second product location 152 and third product location 154 is obtained, distance 162 can be refined and approach a stable distance between the two product locations.

In the embodiment of map 120 shown in FIG. 5, we do not yet know a distance between first product location 150 and third product location 154. Geometric calculations can be used however, as can be deduced from FIG. 5, to quantify the distance between first product location 150 and third product location 154. The distance between first product location 150 and third product location 154 can be as great as the sum of first distance 160 and second distance 162, or as small as the difference between first distance 160 and second distance 162. In this way, geometric calculations can be used to quantify a distance between locations when no data exists.

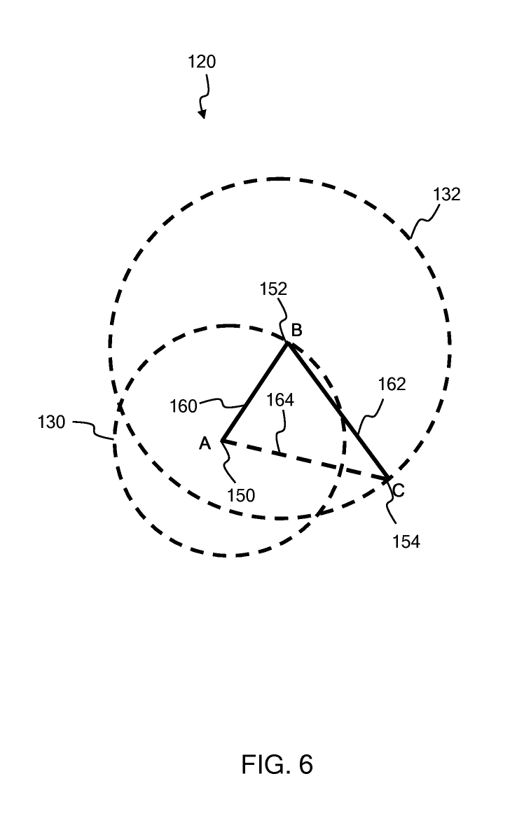

FIG. 6 illustrates what happens when distance 164 is determined by time stamps and barcode scan data. Distance 164 is determined, in this example, when a fourth time stamp is obtained from mobile computing device 106, after mobile computing device 106 travels from third location 154 to first location 150. Distance module 116 will calculate third distance 164 using the third and the fourth time stamps, and mapping module 118 will map third distance 164 on map 120 as shown in FIG. 6.

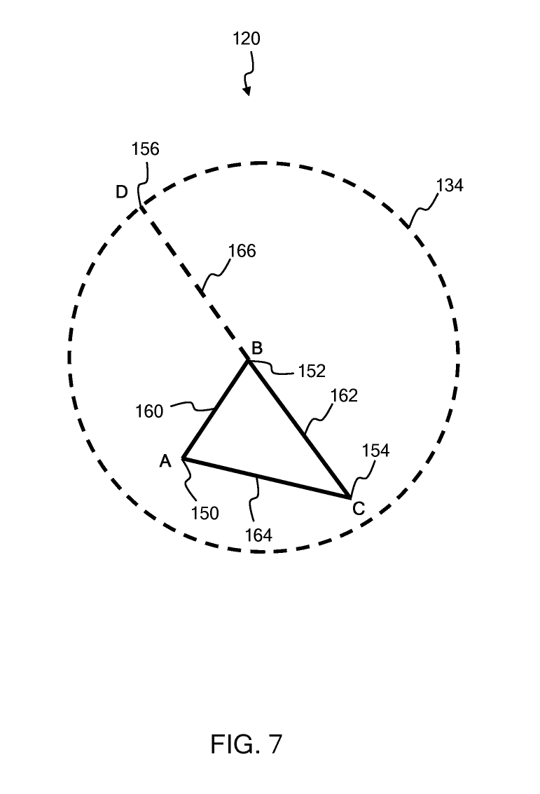

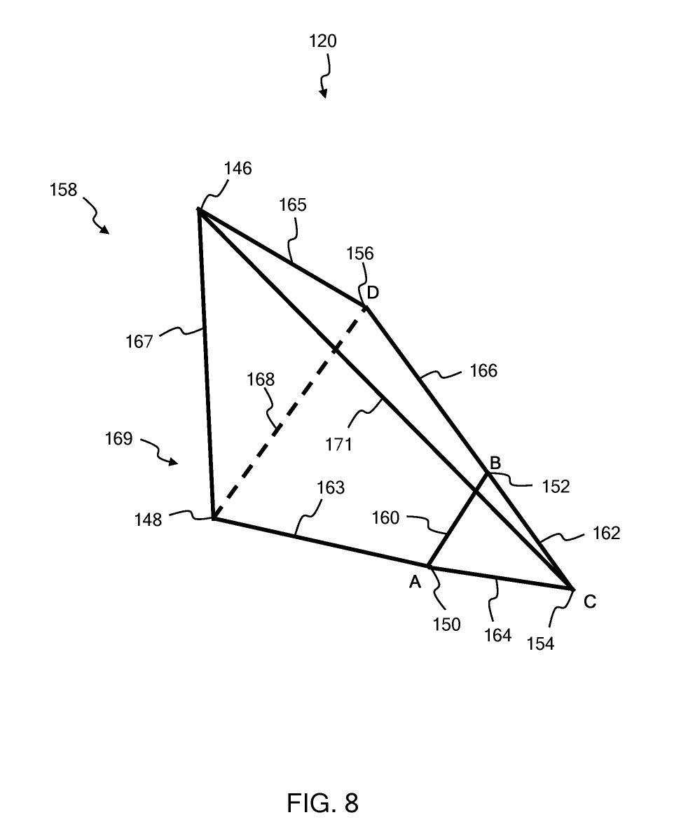

Once locations 150, 152, and 154 the distances 160, 162, and 164 between them are mapped, additional locations and distances are added to map 120 as shown in FIG. 7 and FIG. 8. Distance 166 can be calculated from time stamps and barcode scan data from one of plurality of mobile computing devices 107 being carried between second location 152 and a fourth location 156, as shown in the embodiment of map 120 shown in FIG. 7. FIG. 8 shows an embodiment of map 120 where a number of additional product locations and distances have been added. Map 120 in the embodiment shown in FIG. 8 includes plurality of locations 158 and plurality of distances 169. Distance 166 from location 152 to location 156 has been determined and mapped. Distance 163 from location 150 to location 148 has been determined and mapped, as has distance 171 from location 154 to location 146, distance 167 from location 148 to location 146, and distance 165 from location 156 to location 146. Distance 168 from location 148 to location 156 can be estimated geometrically, or computed from plurality of time stamps 122, plurality of data captures 124, and/or pedometer data 172.

FIG. 4 through FIG. 8 shows how a plurality of distances 169 and a plurality of locations 158 can be mapped on maps 120 using plurality of time stamps 122, plurality of data captures 124, and pedometer data 172 if available. As data builds up from a plurality of mobile computing devices 107 carried by plurality of individuals 105 traveling between plurality of product locations 158, plurality of distances 169 is refined and approach stable values, and map 120 grows to include plurality of locations 158 and distances 169.

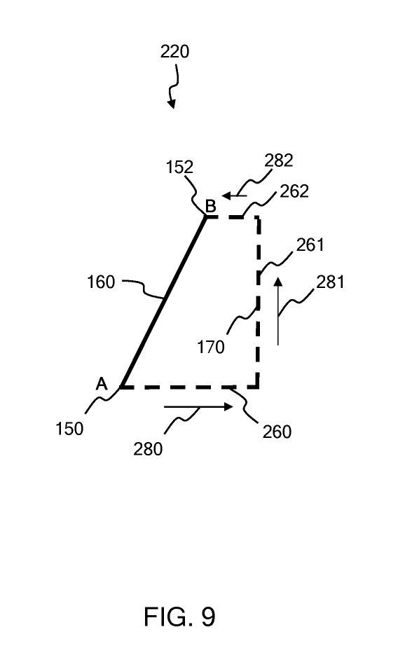

In the embodiment of system for mapping a store 110 shown in FIG. 1, FIG. 2, and FIG. 3 system 110 receives directional data 174 from plurality of mobile computing devices 107. FIG. 9 through FIG. 11 illustrate how directional data 174 is used to map a plurality of directional paths 180 on a map 220, where map 220 is generated by mapping module 118 of system 110.

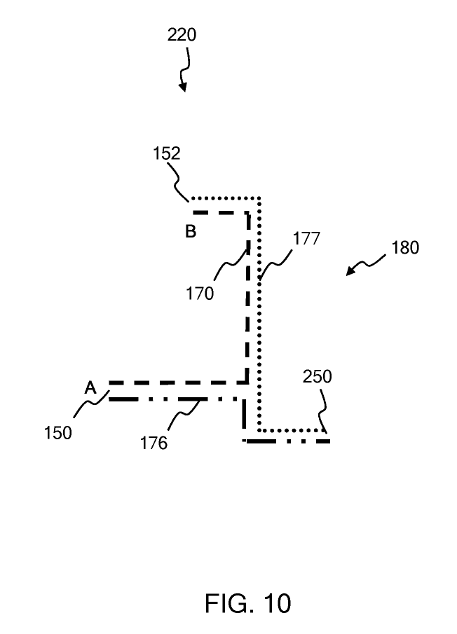

Directional data 174 is received from any one or more than one of plurality of mobile computing devices 107 that have the capability of generating and transmitting directional data 174. Directional data 174 can be compass data, GPS data, or any other type of data that indicates the direction that one of plurality of mobile computing devices 107 is moving as the one of plurality of mobile computing devices 107 moves between two of plurality of locations 158. Directional data is received by mapping module 118 from communication module 114. Mapping module 118 uses directional data 174 to map directional path 170 on map 220 as shown in FIG. 9. Directional data 174 indicates that one of plurality of mobile computing devices 107 travels along path 260 in direction 280, then along path 261 in direction 281, then along path 262 in direction 282, when traveling between product location 150 and 152. Directional path 170, one of plurality of directional paths 180 (FIG. 10), is the addition of paths 260, 261, and 262. Thus, mapping module 118 maps directional path 170 between location 150 and location 152 on map 220.

Using directional data 174 and directional paths 170 to create map 220 allows map 220 to show not only the distance between locations, but the direction one of plurality of individuals 107 travels to get between any two of plurality of locations 158.

FIG. 10 shows map 220 with directional path 177 added, where directional path 177 is the directional path between location 152 and location 250. It should be noted that knowing directional path 170 and directional path 177, directional path 176 between location 150 and location 250 can be deduced. Thus, if an individual needs to know the direction and distance to travel to get from location 150 and location 250, directional path 176 can be provided, deduced from directional path 170 and 177, even if no directional data exists between location 150 and location 250.

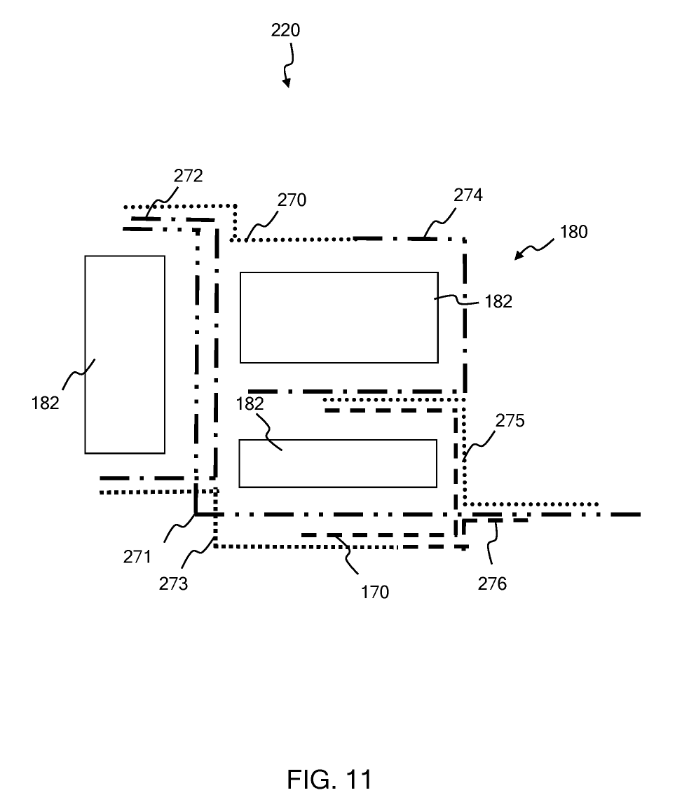

FIG. 11 illustrates map 220 after mapping module 118 has mapped plurality of directional paths 180. Plurality of directional paths 180 includes directional paths 170, 270, 271, 272, 273, 274, 275, and 276. It can be seen that as more directional paths get added to map 220, the physical layout of the store begins to be evident from map 220. Physical features of the store can be mapped onto map 220, providing further map information. In the embodiment of map 220 of FIG. 11, store shelves 182 have been added, illustrating the rows and paths around shelves 182. It can be appreciated that adding additional directional paths, and store features such as cashier stations, feature hardware, backroom details, etc., a useful and refined map 220 will be the result. Map 220 can be used to direct customers, to provide work routes to employees, or to find a nearest employee and direct the employee to an incident. Directions to customers and employees can take the form of directions to travel and the number of steps to take. In some embodiments, map 220 is used to supplement an existing store map. In some embodiments, map 220 is created to replace existing store maps. Plurality of locations 158 on map 220 can be product locations, task locations, physical features locations, or any other type of location on map 220. Map 220 can be used for many different purposes. Map 220 can be a product location map, indicating the location of any or all of the products of the store. Map 220 can be a physical feature location map, or a workstation location map. Map 220 can be tailored to show specific location types, or all location types, or any combination of location types, with or without physical features.

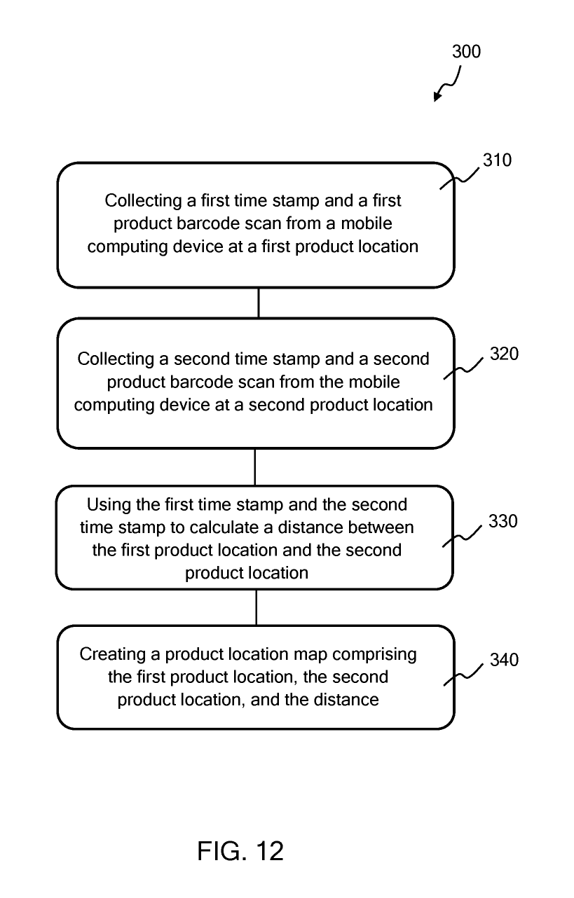

FIG. 12 illustrates a method 300 of mapping product locations. Method 300 of mapping product locations includes element 310 of collecting a first time stamp and a first product barcode scan from a mobile computing device at a first product location. Method 300 also includes element 320 of collecting a second time stamp and a second product barcode scan from the mobile computing device at a second product location. Method 300 of mapping product locations also includes element 330 of using the first and the second time stamps to calculate a distance between the first product location and the second product location. And, method 300 includes element 340 of creating a product location map comprising the first product location, the second product location, and the distance. Method 300 recites collecting product barcode scans from the mobile computing device, but it is to be understood that method 300 can include collecting any type of data capture from the mobile computing device. A data capture can be a scan of a barcode, a QR code, a MICROSOFT™ Tag, or any other type of scanned data entry. A data capture can be a manual entry of barcode data, QR code data, MICROSOFT™ Tag data, or other manual data entry. A data capture can be any receipt of data using a single sensor or a linear array of sensors. A data capture can be the receipt of laser light reflected off a label, barcode, QR code, or other printed label or surface. A data capture can be the capture of a picture using a two-dimensional array of sensors such as a cellphone camera sensor. A data capture can be the receipt of data using near field communications (NFC) devices or other type of electronic or optical data transfer means. A data capture can be the receipt of any form of information recognizable by a mapping system.

Method 300 can include many other elements. In some embodiments, the distance is a first distance, and method 300 also includes collecting pedometer data from the mobile computing device as an individual carrying the mobile computing device moves from the first product location to the second product location. In some embodiments, method 300 includes using the pedometer data to generate a second distance between the first product location and the second product location. In some embodiments, method 300 includes using the second distance to update the first distance. In some embodiments, method 300 includes collecting directional data from the mobile computing device as an individual carrying the mobile computing device moves from the first product location to the second product location. In some embodiments, method 300 includes using the directional data to generate a directional path between the first product location and the second product location. In some embodiments, method 300 includes mapping the directional path on the product location map.

In some embodiments, method 300 includes adding building features to the product location map. In some embodiments, method 300 includes providing directions to a location using the product location map. In some embodiments, method 300 includes identifying an employee closest to an incident using the product location map.

In some embodiments, method 300 includes collecting a third time stamp from the mobile computing device at a third product location, using the second time stamp and the third time stamp to calculate a second distance between the second product location and the third product location, and mapping the third product location and the second distance on the product location map. In some embodiments, method 300 includes using geometric calculations and the first and the second distances to quantify a third distance between the first product location and the third product location. In some embodiments, method 300 includes mapping the third distance on the product location map.

In some embodiments, method 300 includes collecting a fourth time stamp from the mobile computing device at the first product location, using the fourth time stamp and the third time stamp to calculate a third distance between the third product location and the first product location, and mapping the third distance on the product location map.

In some embodiments, method 300 includes collecting additional time stamps from a plurality of additional mobile computing devices carried by any one of a plurality of individuals traveling between the first product location and the second product location, and using the additional time stamps to recalculate the distance between the first product location and the second product location. In some embodiments, method 300 includes collecting a plurality of directional data from the plurality of additional mobile computing devices traveling between the first product location and the second product location, using the plurality of directional data to compute a plurality of directional paths between the first product location and the second product location, and mapping the plurality of directional paths between the first product location and the second product location on the product location map.

In some embodiments, the mobile computing device is a first mobile computing device, the distance is a first distance, and method 300 also includes collecting a third time stamp and a third product scan from a second mobile computing device at a third product location, collecting a fourth time stamp from the second mobile computing device at the second product location, using the third and the fourth time stamps to calculate a second distance between the second product location and the third product location, and mapping the second distance and the third product location on the product location map.

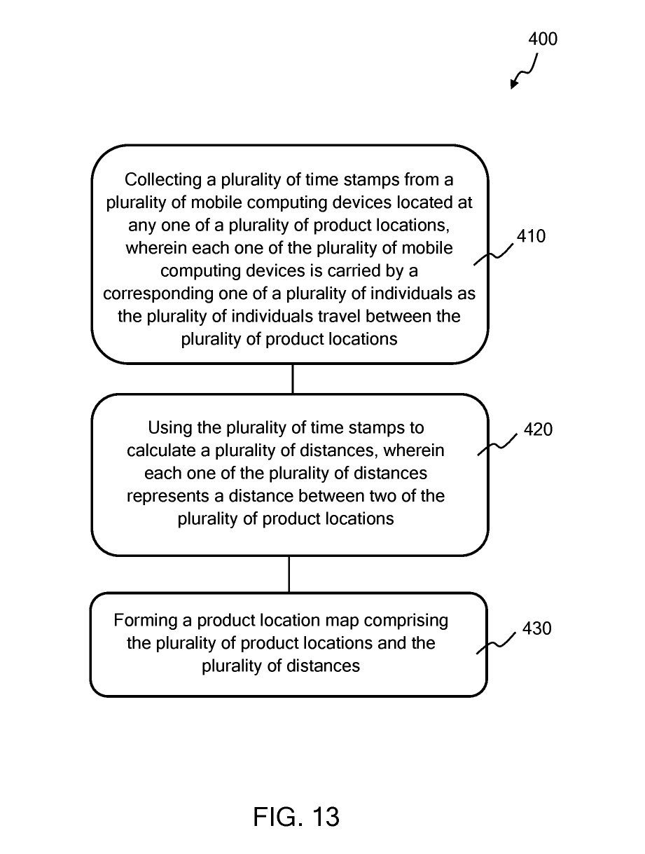

FIG. 13 illustrates a method 400 of mapping product locations. Method 400 of mapping product locations includes element 410 of collecting a plurality of time stamps from a plurality of mobile computing devices located at any one of a plurality of product locations, wherein each one of the plurality of mobile computing devices is carried by a corresponding one of a plurality of individuals as the plurality of individuals travel between the plurality of product locations. Method 400 also includes element 420 of using the plurality of time stamps to calculate a plurality of distances, where each one of the plurality of distances represents a distance between two of the plurality of product locations. Method 400 of mapping product locations also includes forming a product location map comprising the plurality of product locations and the plurality of distances. In some embodiments, method 400 includes collecting directional data from the plurality of mobile computing devices carried by the plurality of individuals. In some embodiments, method 400 includes using the directional data to determine a directional path between any two of the plurality of product locations. In some embodiments, method 400 includes collecting a plurality of pedometer data from the plurality of mobile computing devices. In some embodiments, method 400 includes using the plurality of pedometer data to update the plurality of distances.

As will be appreciated by one skilled in the art, aspects of the disclosed system and method for mapping locations in a retail store may be embodied as a system, method, or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, radio frequencies, etc., or any suitable combination of the foregoing.

Computer program code for carrying out operations for aspects of the present invention may be written in any combination of one or more programming languages, including an object oriented programming language or conventional procedural programming languages, or other similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

While the invention has been shown and described with reference to specific preferred embodiments, it should be understood by those skilled in the art that various changes in form and detail may be made therein without departing from the spirit and scope of the invention as defined by the following claims.

What is claimed is:

1. A system for mapping a retail store comprising:
a communication module, wherein the communication module receives:
a first time stamp from a mobile computing device; and
a second time stamp from the mobile computing device;
a location module, wherein the location module associates the first time stamp to a first location in the retail store, and wherein the location module associates the second time stamp to a second location in the retail store;
a distance module, wherein the distance module uses the first and the second time stamps to compute a distance between the first and the second location; and
a mapping module, wherein the mapping module maps the first and the second location and the distance on a map.

2. The system of claim 1, wherein the communication module receives pedometer data from the mobile communication device as the mobile communication device moves from the first location to the second location.

3. The system of claim 2, wherein the distance is a first distance, and wherein the distance module uses the pedometer data to compute a second distance between the first and the second location.

4. The system of claim 1, wherein the communication module receives a product barcode scan from the mobile computing device, wherein the product barcode scan is associated with the first timestamp.

5. The system of claim 4, wherein the location module assigns a product associated with the product barcode scan to the first location.

6. The system of claim 5, wherein the mapping module maps the product to the first location.

7. The system of claim 1, wherein the communication module receives directional data from the mobile communication device as the mobile communication device moves from the first location to the second location.

8. The system of claim 7, wherein the mapping module uses the directional data to map a directional path between the first location and the second location.

9. The system of claim 1, wherein the mapping module adds building features to the map.

10. A store mapping system comprising:
means for collecting:
a first time stamp associated with a first location in the store; and
a second time stamp associated with a second location in the store;
a distance module that uses the first and the second time stamps to compute a distance between the first and the second location; and
a mapping module that maps the distance and the first and the second locations.

11. The store mapping system of claim 10, further comprising a means for collecting pedometer data from a mobile computing device as the mobile computing device moves from the first location to the second location, wherein the mapping module uses the pedometer data to map the distance.

12. The store mapping system of claim 10, further comprising a means for collecting directional data from a mobile computing device as the mobile computing device moves from the first location to the second location, wherein the mapping module uses the directional data to map a directional path between the first location and the second location.

13. A method of mapping product locations comprising:
collecting a first time stamp and a first product barcode scan from a mobile computing device at a first product location;
collecting a second time stamp and a second product barcode scan from the mobile computing device at a second product location;
using the first and the second time stamps to calculate a distance between the first product location and the second product location; and
creating a product location map comprising the first product location, the second product location, and the distance.

14. The method of claim 13, wherein the distance is a first distance, and further comprising:
collecting pedometer data from the mobile computing device as an individual carrying the mobile computing device moves from the first product location to the second product location;
using the pedometer data to generate a second distance between the first product location and the second product location; and
using the second distance to update the first distance.

15. The method of claim 13, further comprising:
collecting directional data from the mobile computing device as an individual carrying the mobile computing device moves from the first product location to the second product location;
using the directional data to generate a directional path between the first product location and the second product location; and
mapping the directional path on the product location map.

16. The method of claim 13, wherein the distance is a first distance, and further comprising:
collecting a third time stamp from the mobile computing device at a third product location;
using the second time stamp and the third time stamp to calculate a second distance between the second product location and the third product location; and
mapping the third product location and the second distance on the product location map.

17. The method of claim 16, further comprising:
using geometric calculations and the first and the second distances to quantify a third distance between the first product location and the third product location; and
mapping the third distance on the product location map.

18. The method of claim 16 further comprising:
collecting a fourth time stamp from the mobile computing device at the first product location;
using the fourth time stamp and the third time stamp to calculate a third distance between the third product location and the first product location; and
mapping the third distance on the product location map.

19. The method of claim 13, further comprising:
collecting additional time stamps from a plurality of additional mobile computing devices carried by any one of a plurality of individuals traveling between the first product location and the second product location; and
using the additional time stamps to recalculate the distance between the first product location and the second product location.

20. The method of claim 19, further comprising:
collecting a plurality of directional data from the plurality of additional mobile computing devices traveling between the first product location and the second product location;
using the plurality of directional data to compute a plurality of directional paths between the first product location and the second product location; and
mapping the plurality of directional paths between the first product location and the second product location on the product location map.
